(19) United States
(12) Patent Application Publication
(10) Pub. No.: US 2017/0225313 A1
(43) Pub. Date: Aug. 10, 2017

(54) Impact Tool Attachment

(71) Applicant: Daniel Battershell, Brownsville, CA (US)

(72) Inventor: Daniel Battershell, Brownsville, CA (US)

(21) Appl. No.: 15/015,193

(22) Filed: Feb. 4, 2016

(51) Int. Cl. B25D 17/08; B23B 31/12

(52) U.S. Cl. CPC B25D 17/084; B23B 31/1207

(57) ABSTRACT

An impact tool attachment for an impact tool includes a chuck, a shaft and a screw. A first channel is axially positioned in a back face of the chuck. The first channel is right-handedly threaded. The shaft has a first end and a second end. The first end is complementary to the first channel. The second end is hexagonally shaped when viewed longitudinally. The screw is left-handedly threaded. A penetration is axially positioned in the first end of the shaft. The penetration is complementary to the screw. The shaft is threadedly couplable to the first channel and the screw is threadedly couplable to the penetration. The shaft is coupled to the chuck such that the second end is configured to couple the shaft to an impact driver.

### BACKGROUND OF THE DISCLOSURE

### Field of the Disclosure

The disclosure relates to tool attachments and more particularly pertains to a new tool attachment for an impact tool.

### SUMMARY OF THE DISCLOSURE

An embodiment of the disclosure meets the needs presented above by generally comprising a chuck, a shaft and a screw. A first channel is axially positioned in a back face of the chuck. The first channel is right-handedly threaded. The shaft has a first end and a second end. The first end is complementary to the first channel. The second end is hexagonally shaped when viewed longitudinally. The screw is left-handedly threaded. A penetration is axially positioned in the first end of the shaft. The penetration is complementary to the screw. The shaft is threadedly couplable to the first channel and the screw is threadedly couplable to the penetration. The shaft is coupled to the chuck such that the second end is configured to couple the shaft to an impact driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of an impact tool attachment according to an embodiment of the disclosure.

FIG. 2 is an exploded view of an embodiment of the disclosure.

FIG. 3 is a cross-sectional view of an embodiment of the disclosure.

FIG. 4 is a side view of an embodiment of the disclosure.

FIG. 5 is an in-use view of an embodiment of the disclosure.

### DESCRIPTION OF THE PREFERRED EMBODIMENT

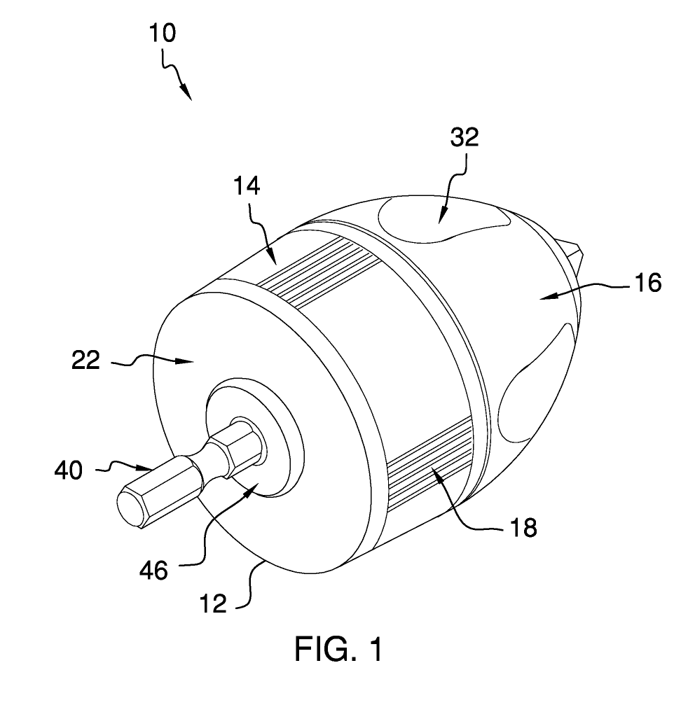

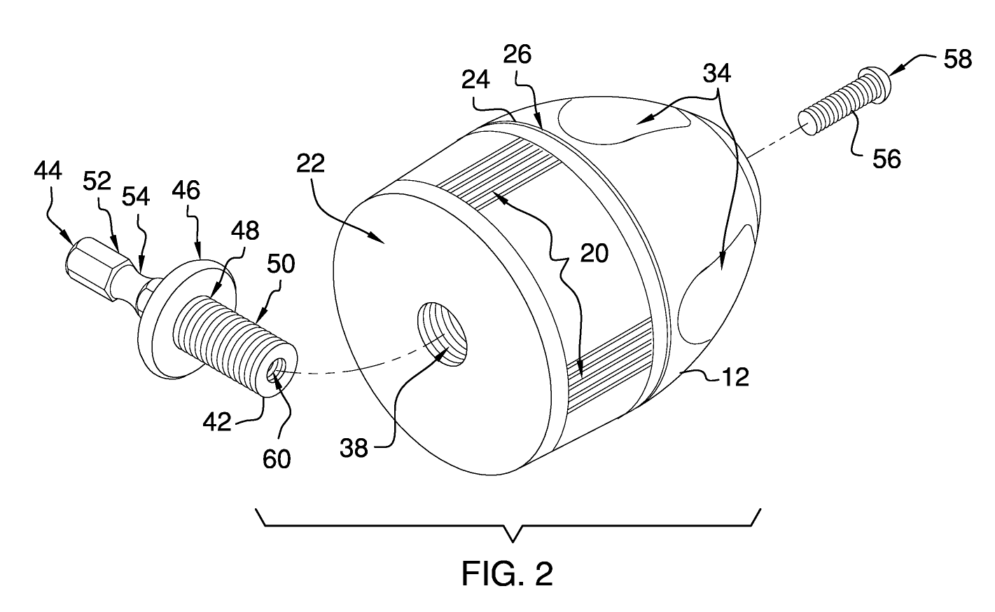

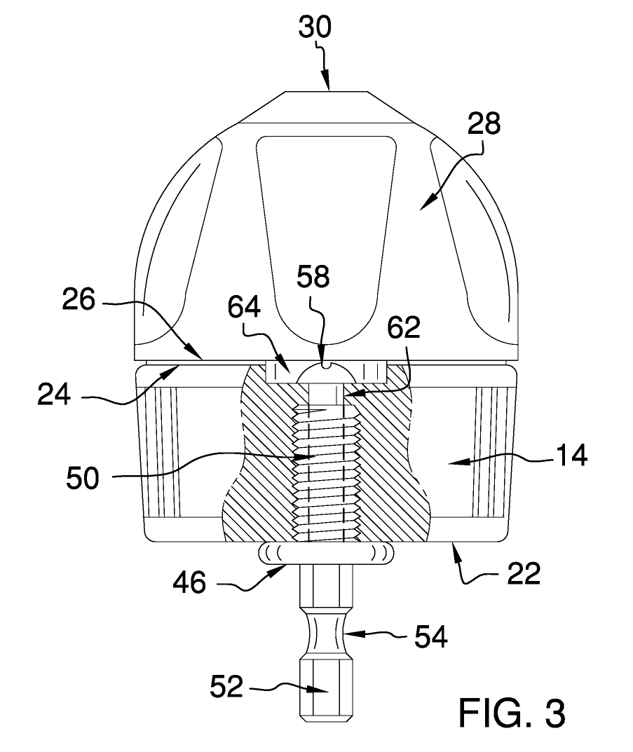

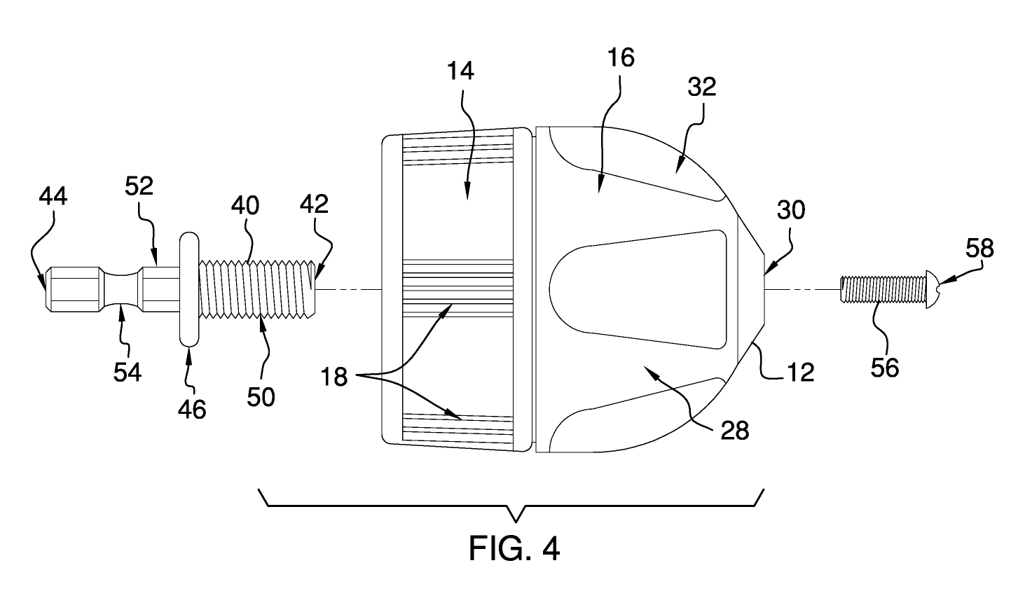

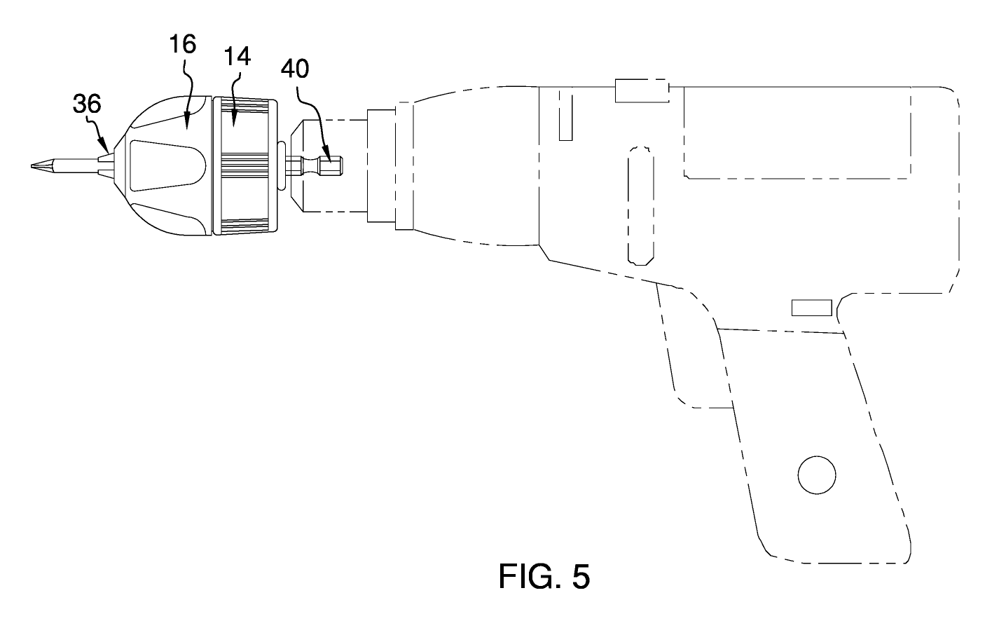

With reference now to the drawings, and in particular to FIGS. 1 through 5 thereof, a new tool attachment embodying the principles and concepts of an embodiment of the disclosure and generally designated by the reference numeral 10 will be described.

As best illustrated in FIGS. 1 through 5, the impact tool attachment 10 generally comprises a chuck 12, which preferably is keyless. More specifically, the chuck 12 comprises a fixed section 14 and a rotatable section 16. The fixed section 14 is substantially cylindrically shaped. A first grip 18, which comprises a plurality of ridges 20, is coupled to the fixed section 14. Preferably, the ridges 20 extend from proximate to a back face 22 of the chuck 12 to proximate to an inner face 24 of the fixed section 14. The rotatable section 16 is operationally coupled to the fixed section 14. The rotatable section 16 has an interior face 26 that is complementary to the inner face 24 of the fixed section 14. The rotatable section 16 also has an annular face 28 that extends between the interior face 26 and a chuck opening 30. The annular face 28 is arcuate, such that the chuck opening 30 is dimensionally smaller than the interior face 26 of the rotatable section 16. A second grip 32 is coupled to the rotatable section 16. Preferably, the second grip 32 comprises a plurality of indentations 34 positioned in the annular face 28 of the rotatable section 16. The indentations 34 are arcuate.

A plurality of jaws 36 is positioned in the chuck opening 30. The jaws 36 are operationally coupled to the rotatable section 16. Preferably, the plurality of jaws 36 comprises three jaws 36. The jaws 36 extend and grip upon clockwise rotation of the rotatable section 16 relative to the fixed section 14. The jaws 36 retract and release upon counter-clockwise rotation of the rotatable section 16 relative to the fixed section 14.

The attachment 10 also comprises a first channel 38 and a shaft 40. The first channel 38 is axially positioned in the back face 22 of the chuck 12. The first channel 38 is right-handedly threaded. The shaft 40 has a first end 42 and a second end 44. The first end 42 is complementary to the first channel 38. The second end 44 is hexagonally shaped when viewed longitudinally.

A collar 46 is coupled to and extends radially from the shaft 40 proximate to a midpoint 48 of the shaft 40. The collar 46 defines a threaded segment 50 of the shaft 40 that extends from the first end 42 to the collar 46. The collar 46 also defines a hexagonal segment 52 of the shaft 40 that extends from the second end 44 to the collar 46. An annular grove 54 is positioned in the hexagonal segment 52 of the shaft40. The annular grove 54 is positioned substantially equally distant from the second end 44 and the collar 46. The annular groove 54 is arcuate.

The attachment 10 also comprises a screw 56 that is left-handedly threaded and has a standard head 58. A penetration 60, complementary to the screw 56, is axially positioned in the first end 42 of the shaft 40. The penetration 60 extends from the first end 42 to proximate to the collar 46.

A second channel 62 extends linearly from the first channel 38 to the inner face 24 of the fixed section 14. The second channel 62 is substantially dimensionally equivalent to the penetration 60. A countersink 64 is axially positioned in the inner face 24 of the fixed section 14. The standard head 58 of the screw 56 is positioned in the counter sink 64 when the screw 56 is threadedly positioned in the penetration 60.

In use, the shaft 40 is threadedly couplable to the first channel 38 positioned through the back face 22 of the chuck 12. The shaft is coupled 40 to the chuck 12 such that the second end 44 is configured to couple the shaft 40 to an impact driver. The jaws 36 are configured to reversibly couple to drill accessories. The screw 56 is threadedly couplable to the penetration 60 to prevent decoupling of the shaft 40 from the chuck 12 during reverse operation of the impact driver.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An impact tool attachment comprising:
a chuck;
a first channel, said first channel being axially positioned in a back face of said chuck, said first channel being right-handedly threaded;
a shaft, said shaft having a first end and a second end, said first end being complementary to said first channel, said second end being hexagonally shaped when viewed longitudinally;
a screw, said screw being left-handedly threaded;
a penetration, said penetration being axially positioned in said first end of said shaft, said penetration being complementary to said screw; and
wherein said shaft is threadedly couplable to said first channel, wherein said screw is threadedly couplable to said penetration, such that said shaft is coupled to said chuck and such that said second end is configured to couple said shaft to an impact driver.

2. The attachment of claim 1, further including said chuck being keyless.

3. The attachment of claim 1, further including said chuck comprising:
a fixed section, said fixed section being substantially cylindrically shaped;
a rotatable section, said rotatable section being operationally coupled to said fixed section, said rotatable section having an interior face, said interior face being complementary to an inner face of said fixed section, said rotatable section having an annular face, said annular face extending between said interior face and a chuck opening, said annular face being arcuate, such that said chuck opening is dimensionally smaller than said interior face of said rotatable section;
a plurality of jaws, said jaws being positioned in said chuck opening, said jaws being operationally coupled to said rotatable section; and
wherein said jaws extend and grip upon clockwise rotation of said rotatable section relative to said fixed section and retract and release upon counter-clockwise rotation of said rotatable section relative to said fixed section.

4. The attachment of claim 3, further including a first grip, said first grip being coupled to said fixed section.

5. The attachment of claim 4, further including said first grip comprising a plurality of ridges, said ridges extending from proximate to said back face of said chuck to proximate to said inner face of said fixed section.

6. The attachment of claim 3, further including a second grip, said second grip being coupled to said rotatable section.

7. The attachment of claim 6, further including said second grip comprising a plurality of indentations positioned in said annular face of said rotatable section, said indentations being arcuate.

8. The attachment of claim 3, further including said plurality of jaws comprising three jaws.

9. The attachment of claim 3, further including a collar, said collar being coupled to and extending radially from said shaft proximate to a midpoint of said shaft, said collar defining a threaded segment of said shaft extending from said first end to said collar, said collar defining a hexagonal segment of said shaft extending from said second end to said collar.

10. The attachment of claim 9, further including an annular grove, said annular groove being positioned in said hexagonal segment of said shaft, said annular grove being positioned substantially equally distant from said second end and said collar, said annular groove being arcuate.

11. The attachment of claim 1, further including said screw having a standard head.

12. The attachment of claim 11, further comprising:
said penetration extending from said first end to proximate to said collar;
a second channel, said second channel extending linearly from said first channel to said inner face of said fixed section, said second channel being substantially dimensionally equivalent to said penetration;
a countersink, said countersink being axially positioned in said inner face of said fixed section; and
wherein said standard head of said screw is positioned in said counter sink when said screw is threadedly positioned in said penetration.

13. An impact tool attachment comprising:
a chuck, said chuck being keyless, said chuck comprising:
a fixed section, said fixed section being substantially cylindrically shaped,
a first grip, said first grip being coupled to said fixed section, said first grip comprising a plurality of ridges, said ridges extending from proximate to a back face of said chuck to proximate to an inner face of said fixed section,
a rotatable section, said rotatable section being operationally coupled to said fixed section, said rotatable section having an interior face, said interior face being complementary to said inner face of said fixed section, said rotatable section having an annular face, said annular face extending between said interior face and a chuck opening, said annular face being arcuate, such that said chuck opening is dimensionally smaller than said interior face of said rotatable section,
a second grip, said second grip being coupled to said rotatable section, said second grip comprising a plurality of indentations positioned in said annular face of said rotatable section, said indentations being arcuate,
a plurality of jaws, said jaws being positioned in said chuck opening, said jaws being operationally coupled to said rotatable section, said plurality of jaws comprising three jaws, and
wherein said jaws extend and grip upon clockwise rotation of said rotatable section relative to said fixed section and retract and release upon counter-clockwise rotation of said rotatable section relative to said fixed section;
a first channel, said first channel being axially positioned in a back face of said chuck, said first channel being right-handedly threaded;
a shaft, said shaft having a first end and a second end, said first end being complementary to said first channel, said second end being hexagonally shaped when viewed longitudinally;
a collar, said collar being coupled to and extending radially from said shaft proximate to a midpoint of said shaft, said collar defining a threaded segment of said shaft extending from said first end to said collar, said collar defining a hexagonal segment of said shaft extending from said second end to said collar;
an annular grove, said annular groove being positioned in said hexagonal segment of said shaft, said annular grove being positioned substantially equally distant from said second end and said collar, said annular groove being arcuate;
a screw, said screw being left-handedly threaded, said screw having a standard head;
a penetration, said penetration being axially positioned in said first end of said shaft, said penetration being complementary to said screw, said penetration extending from said first end to proximate to said collar;
a second channel, said second channel extending linearly from said first channel to said inner face of said fixed section, said second channel being substantially dimensionally equivalent to said penetration;
a countersink, said countersink being axially positioned in said inner face of said fixed section, such that said standard head of said screw is positioned in said counter sink when said screw is threadedly positioned in said penetration; and
wherein said shaft is threadedly couplable to said first channel, wherein said screw is threadedly couplable to said penetration, such that said shaft is coupled to said chuck and such that said second end is configured to couple said shaft to an impact driver and said jaws are configured to reversibly couple to drill accessories.
